(19) United States
(12) Patent Application Publication
(10) Pub. No.: US 2022/0318861 A1
(43) Pub. Date: Oct. 6, 2022

(54) AUTOMATED USER RATING SCORE ACCURACY ESTIMATION

(71) Applicant: International Business Machines Corporation, Armonk, NY (US)

(72) Inventors: Zachary A. Silverstein, Austin, TX (US); Kelley Anders, East New Market, MD (US); Daphne Coates, St. Leonards On Sea (GB); Jonathan D. Dunne, Dungarvan (IE)

(21) Appl. No.: 17/223,480

(22) Filed: Apr. 6, 2021

(51) Int. Cl. G06Q 30/02; G06F 40/20; G06Q 50/00

(52) U.S. Cl. CPC G06Q 30/0282; G06F 40/20; G06Q 50/01

(57) ABSTRACT

Disclosed embodiments provide techniques for estimating the accuracy of a user rating score. In embodiments, a user rating score is obtained from a user. Online activity events such as social media posts, purchases, cancellations, online reviews, and/or other activities are analyzed by a computer system to determine a level of agreement between the score the user provided, and the online activity events of the user that pertain to the product and/or service to which the score pertains. A user rating score reliability factor is computed based on the level of agreement and can be made available to stakeholders such as product managers, marketing personnel, and sales teams.

### FIELD

Disclosed embodiments relate generally to computer systems, and more particularly, to automated user rating score accuracy estimation.

### BACKGROUND

Customer feedback is a vital part of any modern enterprise. Companies, products, services, etc. are judged by potential customers based on the feedback from other customers through reviews. There are many avenues from which people provide feedback, such as through ratings websites, such as Yelp®, or social media websites such as Facebook® or Instagram®. Companies also gauge their own success or weakness based on such reviews. These reviews help direct people and companies in how to change, update, and fine-tune their products, services, and business plans, etc. for improved future implementations.

### SUMMARY

In one embodiment, there is provided a computer-implemented method for estimating an accuracy of a user rating score comprising: obtaining the user rating score from a user for an artifact; retrieving an online activity event from the user, wherein the online activity event is associated with the artifact; computing an agreement factor between the online activity event and the user rating score; and based on the agreement factor, generating a user rating score reliability factor.

In another embodiment, there is provided an electronic computation device comprising: a processor; a memory coupled to the processor, the memory containing instructions, that when executed by the processor, cause the electronic computation device to: obtain a user rating score from a user for an artifact; retrieve an online activity event from the user, wherein the online activity event is associated with the artifact; compute an agreement factor between the online activity event and the user rating score; and based on the agreement factor, generate a user rating score reliability factor.

In yet another embodiment, there is provided a computer program product for an electronic computation device comprising a computer readable storage medium having program instructions embodied therewith, the program instructions executable by a processor to cause the electronic computation device to: obtain a user rating score from a user for an artifact; retrieve an online activity event from the user, wherein the online activity event is associated with the artifact; compute an agreement factor between the online activity event and the user rating score; and based on the agreement factor, generate a user rating score reliability factor.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is an environment for embodiments of the present invention.

FIG. 2 shows a block diagram of a client device in accordance with embodiments of the present invention.

FIG. 3 is a flowchart showing process steps in accordance with embodiments of the present invention.

FIG. 4 is a flowchart showing additional process steps in accordance with embodiments of the present invention.

FIG. 5 shows an exemplary user rating score query in accordance with embodiments of the present invention.

FIG. 6 shows an exemplary social media post used in accordance with embodiments of the present invention.

FIG. 7 shows data structures for user rating score accuracy estimation in accordance with embodiments of the present invention.

FIG. 8 shows an exemplary screen displaying a report including a user rating score reliability factor in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide techniques for estimating the accuracy of a user rating score. In embodiments, a user rating score is obtained from a user. Online activity events such as social media posts, purchases, cancellations, online reviews, and/or other activities are analyzed by a computer system to determine a level of agreement between the score the user provided, and the online activity events of the user that pertain to the product and/or service to which the score pertains. A user rating score reliability factor is computed based on the level of agreement and can be made available to stakeholders such as product managers, marketing personnel, and sales teams. Since user scores are heavily relied upon for strategic and planning purposes, having an indication of the reliability of such scores can serve to improve the technical field of automated evaluation of customer satisfaction.

There are a variety of scores that businesses use to receive ratings from customers, such as net promoter score (NPS), customer effort score (CES), or customer satisfaction score (CSAT). A net promoter score (NPS) is the percentage of customers rating a likelihood to recommend a business, product, or service to another person (9 or 10 on a scale of 1 to 10) minus the percentage rating at 6 or below on that scale. People likely to recommend are considered “promoters,” people rating 6 or below are considered “detractors,” and people who submit a score of 7 or 8 are considered “passives.” A result of this computation is expressed without a percentage sign. This system is a tool used as a measure of customer loyalty, and has been shown to correlate with revenue growth.

A customer effort score is an indicator of customer loyalty. It is a measure of the amount of effort a customer has to exert to get resolution of an issue, fulfillment of a request, return or purchase of a product, or a question answered. CES surveys generally ask, “on a scale of ‘very easy’ to ‘very difficult’, how easy was it to interact with [company, business, or person].” The basis is that customers are more loyal to a product or service that is easier to use.

CSAT is another type of customer loyalty measurement. It indicates how satisfied a customer is with a particular interaction or overall experience. Embodiments are not limited to any of the above scores, but can be used with any of these or other scores now known or hereafter developed.

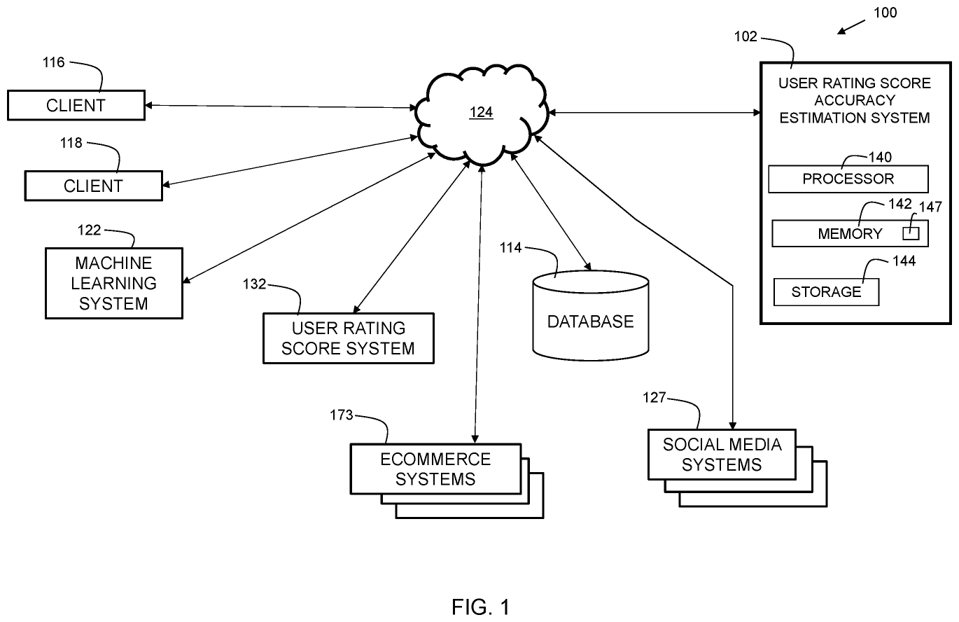

FIG. 1 is an environment for embodiments of the present invention. At 102, there is a user rating score accuracy estimation system. System 102 is an electronic computation device. System 102 includes a processor 140, memory 142, and storage 144. Memory comprises instructions, which when executed by the processor, cause system to implement embodiments of the invention. System 102 is in communication with network 124. Network 124 may be the internet, a wide area network, a local area network, a cloud network, or other suitable network.

Social media systems 127 are also connected to network 124. Social media systems are systems where users can typically set up account profiles for themselves, and connect with other user's account profiles. The systems allow users to post text, images, videos, and other content, as well as send private messages between users and groups. Examples of such systems include Facebook®, Instagram®, LinkedIn®, etc. Some social media systems also include mechanisms for accepting and aggregating user-submitted ratings, such as Yelp®, TripAdvisor®, etc.

Database 114 is connected to network 124. Database 114 stores information used by client devices 116 and 118. This information can include user profiles and associated user records. The associated user records can include purchase histories, subscriptions, memberships, and/or other relevant data used for determining user rating score accuracy.

Ecommerce systems 173 are connected to network 124. Ecommerce systems 173 are online systems where users can purchase various items or services from the ecommerce system (like, Macys.com), or from a third party through the ecommerce system (like Etsy, or Amazon). They can be online stores or marketplaces.

Also connected to network 124 is user rating score system 132. This is an existing system that implements a user rating system such as net promoter score (NPS), customer effort score (CES), customer satisfaction score (CSAT), or other score now known or developed in the future.

Also connected to network 124 is machine learning system 122. This system uses machine learning and artificial intelligence to perform natural language processing (NLP) on social media posts and/or other online activities performed by a user.

Client devices 116 and 118 are shown connected to network 124. These computing devices are used by users to communicate with the user rating score accuracy estimation system and other items on the network. Client devices 116 and 118 may be laptop computers, desktop computers, smartphones, tablets, or other suitable devices. In practice, there may be more or fewer client devices than the two shown in FIG. 1.

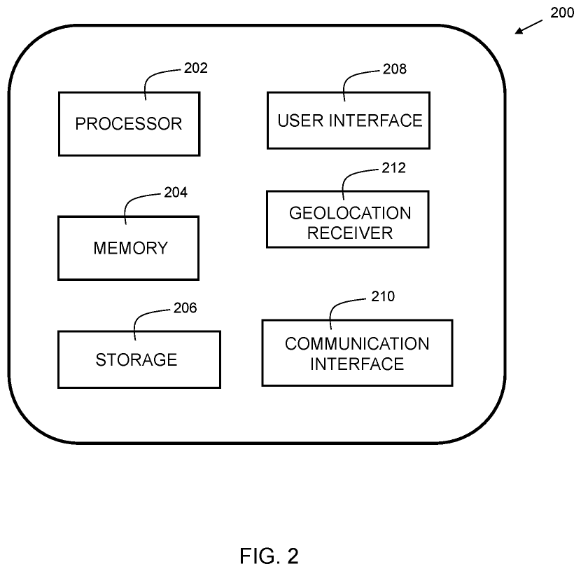

FIG. 2 shows a block diagram of an electronic device used with embodiments of the present invention that may act as a client device such as 116 or 118 of FIG. 1. Device 200 can be a smartphone, tablet computer, or other computing device. Device 200 includes a processor 202, which is coupled to a memory 204. Memory 204 may include dynamic random-access memory (DRAM), static random-access memory (SRAM), magnetic storage, and/or a read only memory such as flash, EEPROM, optical storage, or other suitable memory. In some embodiments, the memory 204 may not be a transitory signal per se.

Device 200 may further include storage 206. In embodiments, storage 206 may include one or more magnetic storage devices such as hard disk drives (HDDs). Storage 206 may additionally include one or more solid state drives (SSDs).

Device 200 further includes user interface 208. This may be a display, such as an LED display, a touch-sensitive screen, a keyboard, a mouse, or any other suitable interface for a user to interact with device 200.

The device 200 further includes a communication interface 210. The communication interface 210 may be a wired communication interface that includes Ethernet, Gigabit Ethernet, or the like. In embodiments, the communication interface 210 may include a wireless communication interface that includes modulators, demodulators, and antennas for a variety of wireless protocols including, but not limited to, Bluetooth™, Wi-Fi, and/or cellular communication protocols for communication over a computer network.

Device 200 may further include geolocation system 212. In embodiments, geolocation system 212 includes a Global Positioning System (GPS), GLONASS, Galileo, or other suitable satellite navigation system.

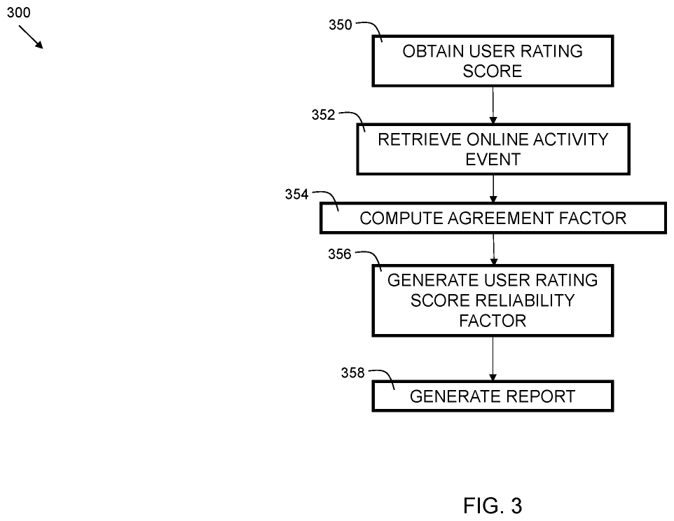

FIG. 3 is a flowchart 300 showing process steps in accordance with embodiments of the present invention. The steps can result in a report that is useful in the technical fields of computerized online marketing analysis, computerized online advertising analysis, and others.

At 350, a user rating score is obtained. In embodiments, the user rating score can include a Net Promoter Score (NPS), Customer Effort Score (CES), and/or Customer Satisfaction Score (CSAT).

At 352, an online activity event is retrieved. An online activity event is an action of the user online with respect to a product or service. Examples can be a social media post, purchase, booking, cancellation, reservation, etc.

At 354, an agreement factor is computed. In embodiments, the agreement factor F is computed as follows:

F=K₁(A)+K₂(B)+K₃(C)+K₄(D), where:

K₁-K₄ are constants used to fine-tune the agreement factor F.

In the example, A may be number of social media posts the month following the event (e.g., purchase). B may be the average duration of time between the posts and the event. C may be number of cancellations. D may be the number of purchases of the next event, which is related to the first event. K may be any suitable predetermined constant, for example, having a value of 2. Factors can be added or deleted as needed. A higher value of F corresponds to a more reliable user-provided score (independently of if the score is favorable or unfavorable regarding the artifact (product or service).

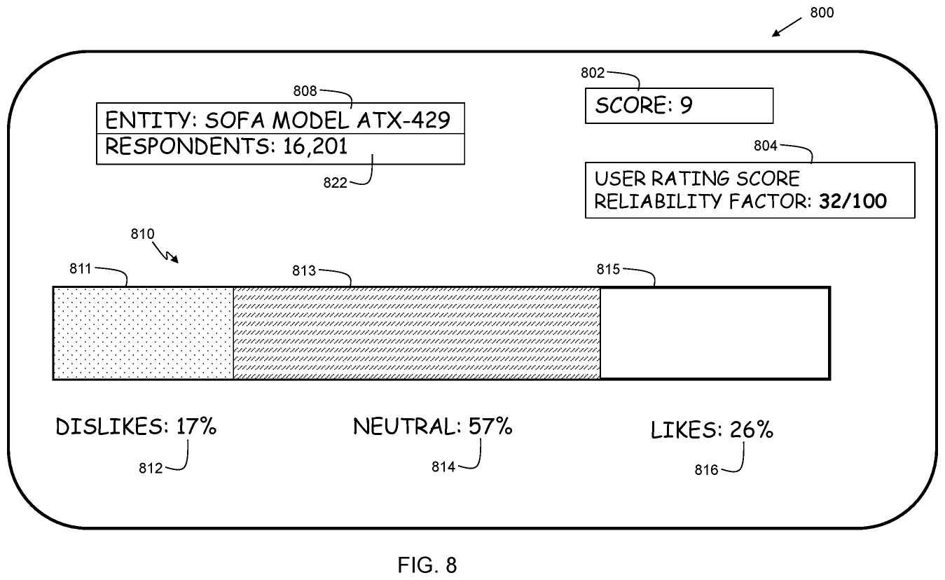

At 356, a user rating score reliability factor is generated based on the formula above, or other suitable formula. At 358, a report is generated, such as that shown in FIG. 8. This report can help a stakeholder digest the information and analyze a user rating score such as NPS, CES, CSAT, or other result. Since stakeholders often make strategic decisions based on the user rating score, it is desirable to assess the reliability of the user score itself. Disclosed embodiments perform this in an automated manner by using machine learning to analyze online activity of the user, and make an assessment of how the online activity aligns with the user score provided by the user. If the online activity does not align with the rating then a low reliability factor is given. An example of misaligned user activity is when a user gives a poor rating for a product in a user rating score, but then later praises the product on social media. Conversely, if the online activity does align with the rating score given by the user, then a high reliability factor is given. In some embodiments, the agreement factor may be normalized for a given range. In some embodiments, the range is 0 to 100, where 100 indicates a very reliable user rating score, and 0 indicates a very unreliable rating score.

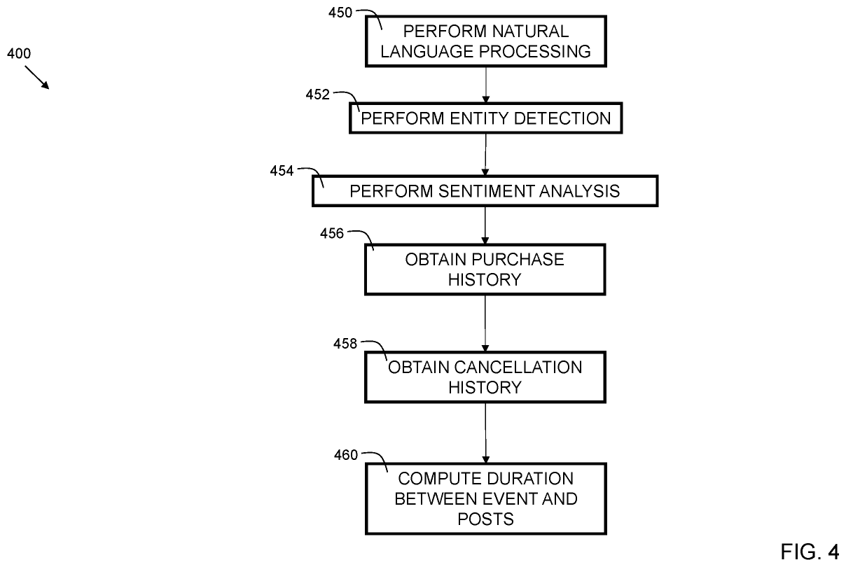

FIG. 4 is a flowchart 400 showing additional process steps in accordance with embodiments of the present invention. In embodiments, a user may opt-in to allow systems to access and analyze the social media posts, purchase history, and/or other online activity associated with the user. At 450, natural language processing is performed. Embodiments may perform a disambiguation process, a dispersion analysis, a bigram analysis, or other suitable process to determine data associated with the online activity. In embodiments, a natural language processing system implemented within machine learning system 122 (FIG. 1) parses natural language, and may perform various tasks such as tokenization, part-of-speech identification, disambiguation, language identification, and/or other processes. The machine learning system 122 (FIG. 1) may then perform other language analysis such as entity detection at 452 and sentiment analysis at 454 to determine a subject and sentiment of social media posts. At 452, entity detection is performed. At 454, sentiment analysis is performed. In embodiments, the sentiment analysis can include computer-implemented processes for anaphora resolution, named-entity recognition, and/or contrastive conjunction. At 456, a purchase history is obtained. In embodiments, the purchase history is obtained from ecommerce systems 173. At 458, cancellation history is obtained. In embodiments, the cancellation history is obtained from ecommerce systems 173. The cancellation history can be used to detect mismatches between a user rating score and online activities. As an example, if a user provided a positive user rating score for a streaming service, but then cancelled that streaming service a few days later, it can indicate that the user's rating score was higher than how the user truly felt about the streaming service.

At 460, a duration between event and posts is computed. In some instances, the passage of time softens negative opinions. In a case where there are positive posts for a product by a user that took place a week after that same user provided a negative score for that same product, then those posts may indicate a discrepancy between the given score and how the user truly feels. Since many businesses make decisions on these scores, embodiments providing an indication of how reliable the scores truly are can be an important factor in improving the technical field of evaluation of customer satisfaction.

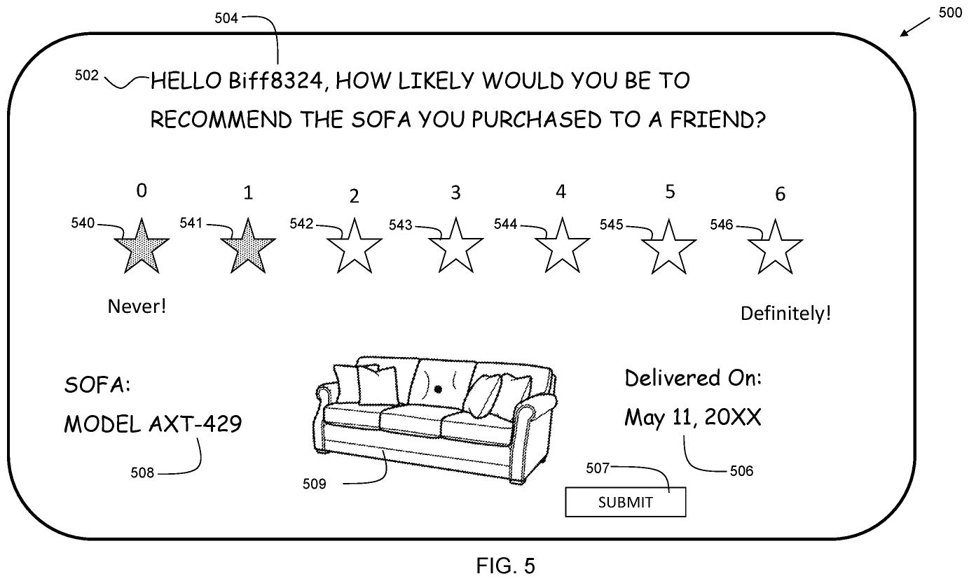

FIG. 5 shows an exemplary user rating score screen in accordance with embodiments of the present invention. At 502, there is a query. At 504, there is a field indicating the user's user ID. This can be an alphanumerical or symbolic string of a user's choosing, or can be automatically generated. At 508, there is an artifact identifier—the identifier of the product or service. In the example, it is a sofa with model number AXT-429. An image of the product is shown at 509. At 506, there is the date of delivery to the customer.

Screen 500 includes an option for user input of a rating that may be rendered on a client device such as 116 of FIG. 1. In the example, the inputs are shown here as stars, 540, 541, 542, 543, 544, 545, and 546. The stars correspond to ratings 0, 1, 2, 3, 4, 5, and, 6, respectively. A user can click using a mouse, or select via a finger on a touch screen the rating which they choose to enter. Here, the user has selected the star 541 associated with the rating “1.” Therefore, the stars 540 and 541 become highlighted. When the user invokes the “submit” button 507, it causes the client device to send the user rating information to the user rating score system 132 via network 124. The user rating score may also be stored in database 114 for future use by user rating score accuracy estimation system 102. Note that the inputs as stars is an example, and another suitable input mechanism (e.g., dropdown menu, radio buttons, text field, etc.) can be substituted within the scope of the invention.

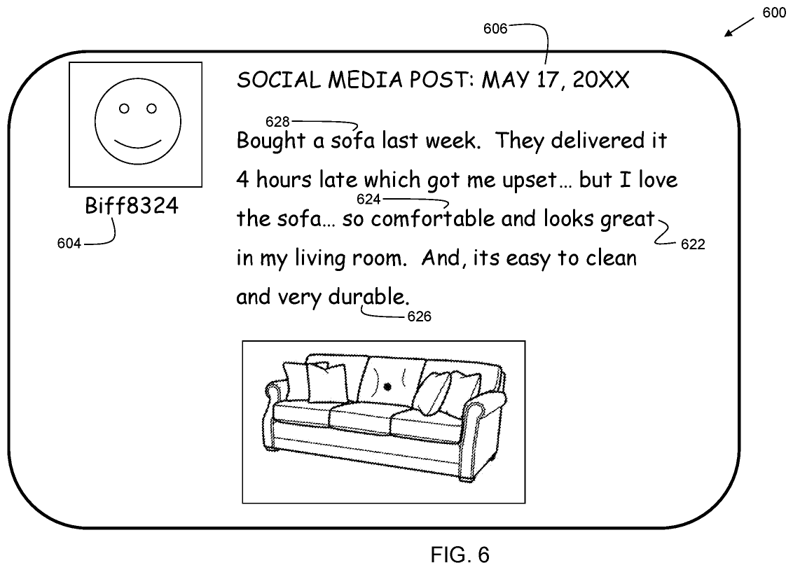

FIG. 6 shows an exemplary social media post used in accordance with embodiments of the present invention. On the screen is shown a user id and a profile picture of the user. The example post is entered by the user, “Bought a sofa last week. They delivered it 4 hours late which got me upset . . . but I love the sofa . . . so comfortable and looks great in my living room. And, its easy to clean and very durable.”

On the sample social media post, the posting date 606 can be important because the difference between the date of the post (May 17) and date of event (May 11 as shown in FIG. 5) can indicate that the user emotions had time to stabilize, and this post may better reflect how they really feel. An entity detection process may identify nouns such as “sofa” at 628 and determine that this social media post pertains to a sofa. The user rating score accuracy estimation system 102 may determine that the user with the user ID indicated at 604 also recently submitted a user rating score pertaining to a sofa (as shown in FIG. 5), and associate the social media post of FIG. 6 with the user rating score shown in FIG. 5. Thus, disclosed embodiments can automatically correlate a social media post shown with a previously submitted user rating score.

In this example, after the passage of several days as indicated by posting date 606 as compared to the user rating score date indicated at 506 of FIG. 5, the user is posting favorably regarding the sofa. In embodiments, adjectives such as, “great” 622, “comfortable” 624, and “durable” 626 may be identified by the natural language processing within system 122 (FIG. 1) in order to gauge sentiment. Thus, there is a misalignment between the positive sentiment given on May 17, and the negative user rating score that the user gave on May 11 (FIG. 5). This mismatch in sentiment between the post and the user score indicates a reduced reliability of the user rating score, which is reflected in a reliability factor.

Conversely, if on May 17, the user indicates that he/she is still unhappy with the couch, then it indicates confirmation of the score provided in FIG. 5 as likely being accurate (i.e., the user is truly unhappy with the sofa). In that scenario, a higher user rating score reliability factor is generated.

Thus, embodiments can include performing a sentiment analysis on the social media post to determine a post sentiment; comparing the post sentiment to a favorability of the user rating score; and in response to determining a mismatch between post sentiment and the favorability, reducing the user rating score reliability factor.

Accordingly, embodiments can include performing a natural language processing (NLP) analysis on the social media post. Embodiments may further include performing a sentiment analysis on the social media post to determine a post sentiment; comparing the post sentiment to a favorability of the user rating score; and in response to determining a mismatch between post sentiment and the favorability, reducing the user rating score reliability factor. In embodiments, the online activity event comprises a social media post pertaining to a service, and embodiments can further include determining a render date for the service; determining a posting date for the social media post; computing a duration between the render date and the posting date, and adjusting the user rating score reliability factor based on the duration.

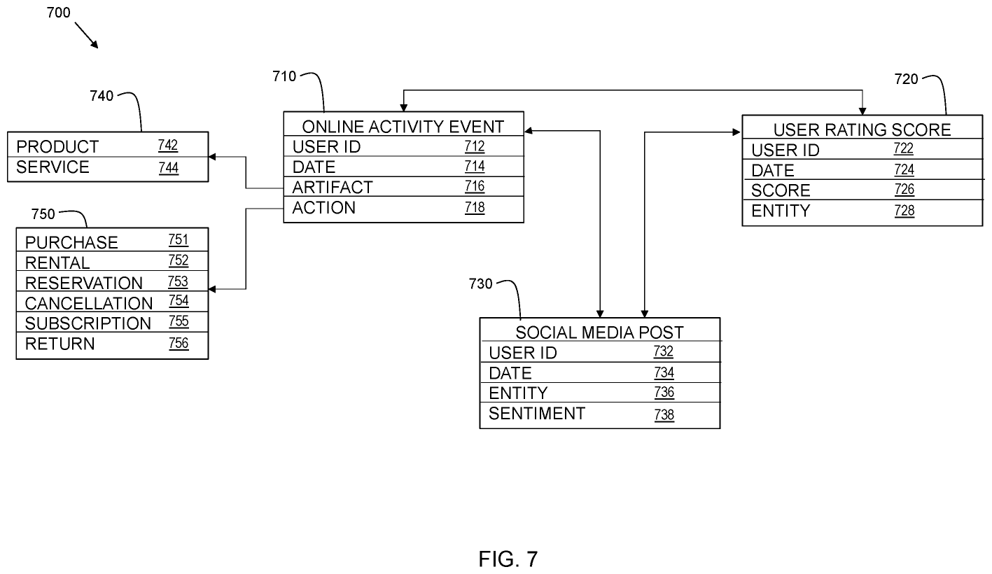

FIG. 7 is a diagram 700 showing data structures for user rating score accuracy estimation in accordance with embodiments of the present invention. The structures may be implemented in a database, such as a relational database, SQL database, or other suitable data storage techniques.

Table 710 includes data related to online activity events. The table includes fields for user id 712 (corresponding to a particular use), date 714 (date of the action), artifact 716 (product or service), and the action 718.

The action table 750 lists some of the possible online activity events that can be used as factors in computing a user rating score reliability factor. In embodiments, the online activity event can include a social media post, purchase, reservation, review, and/or cancellation. Accordingly, the table includes fields for purchase 751, rental 752, reservation 753, cancellation 754, subscription 755, and return 756. Accordingly, a user may purchase, rent, reserve, cancel, subscribe to, or return a particular artifact/entity.

Artifact table 740 includes types of artifacts. In the example, there is product field 742 and service field 744.

Table 730 includes data relating to social media posts. Accordingly, it has a field for user ID 732, date of the post 734, entity 736, and sentiment 738. In embodiments, the date of the post 734 may be stored in seconds using GPS epoch, stored as UTC time, or other suitable time referencing system. Entity 736 refers to a specific artifact, such as a product or service inferred from analyzing a social media post. Examples can include a product (e.g., sofa), or a service (e.g., streaming media subscription, airline flight, etc. . . . ).

Table 720 includes user rating scores. Field 722 includes user ID, field 724 includes the date, field 726 includes the score, and field 728 includes the entity. It should be recognized that this database is an example, and in practice, more or fewer fields or tables may be included within the scope of the invention.

FIG. 8 shows an exemplary screen 800 displaying a report having a user rating score reliability factor in accordance with embodiments of the present invention. This is a dashboard that a stakeholder such as product manager for the company selling the sofa may see. This report shows the aggregate of responses from 16,201 respondents (indicated at 822) relating to the entity (i.e., artifact), sofa model ATX-429, shown in field 808. Based on the responses, a user rating score reliability factor in the example is 32/100, shown at field 804. That indicates that the score of 9, shown in field 802, is not very reliable. In some embodiments, a score of 75 or higher is deemed to be reliable, while a score between 40 up to 75 is deemed to be somewhat reliable, and a score less than 40 is deemed to be unreliable. In embodiments, the formulas may be adjusted to use different ranges and/or limits to indicate score reliability.

While this example shows approximately 16 thousand respondents at field 822, in practice there can be hundreds of thousands, or millions of respondents. Disclosed embodiments utilize computer-implemented methods to analyze up to millions or tens of millions of online activities to quickly assess the reliability of a user score in a way that is not possible or practical with manual techniques.

In some scoring systems, the responses are divided into a negative, neutral and positive category, where the neutrals are discarded. Following such an approach, in this example, the score is 9 which is derived from 26% of likes, shown at 816, minus 17% of dislikes shown at 812. The 57% of neutrals are discarded. At 810 in the report, the amount of dislikes, neutrals, and likes are shown graphically as graph portion 811, graph portion 813, and graph portion 815, respectively. The graphical representation serves to help the stakeholder visualize the results for ease of reference.

The score shown in the example of FIG. 8 of 32/100 indicates to the stakeholder that the score may be unreliable, based on subsequent activities of the users that participated (822). In this example, many of the users later posted differently about the sofa than how they rated it, or did other online activities like return a sofa, or buy another sofa of the same type, for example. It should be recognized that this report is an example, and in practice, more or fewer items may be included within the scope of the invention.

As can now be appreciated, disclosed embodiments provide an analysis model for the difference between user rating score and user actions. This is accomplished by determining, using natural language processing techniques, what the content and sentiment of that action is. By knowing the reliability of a user rating score, it is possible to project the user's likelihood of continuing on a positive or negative consumer trajectory. Thus, disclosed embodiments improve the technical field of data analysis by computing a user rating score reliability factor for a population of users. In situations with a large customer base having millions of customers, gauging customer satisfaction benefits from automated techniques. User feedback scores are often used to drive strategy, advertising campaigns, product roadmaps, and other strategic business decisions. Thus, the reliability of the user-provided scores is an important factor for stakeholders to consider prior to making decisions in these areas. Disclosed embodiments provide an indication of the reliability, allowing stakeholders to effectively make use of user-provided rating scores for products and services.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for estimating an accuracy of a user rating score comprising:
obtaining the user rating score from a user for an artifact;
retrieving an online activity event from the user, wherein the online activity event is associated with the artifact;
computing an agreement factor between the online activity event and the user rating score; and
based on the agreement factor, generating a user rating score reliability factor.

2. The method of claim 1, wherein the artifact is a product.

3. The method of claim 1, wherein the artifact is a service.

4. The method of claim 1, wherein the online activity event comprises a social media post.

5. The method of claim 1, wherein the online activity event comprises a purchase.

6. The method of claim 3, wherein the online activity event comprises a reservation.

7. The method of claim 3, wherein the online activity event comprises a cancellation.

8. The method of claim 1, wherein the user rating score comprises a Net Promoter Score (NPS).

9. The method of claim 1, wherein the user rating score comprises a Customer Effort Score (CES).

10. The method of claim 1, wherein the user rating score comprises a Customer Satisfaction Score (CSAT).

11. The method of claim 4, further comprising performing a natural language processing (NLP) analysis on the social media post.

12. The method of claim 11, further comprising:
performing a sentiment analysis on the social media post to determine a post sentiment;
comparing the post sentiment to a favorability of the user rating score; and
in response to determining a mismatch between post sentiment and the favorability, reducing the user rating score reliability factor.

13. The method of claim 3, wherein the online activity event comprises a social media post, and further comprising:
determining a render date for the service;
determining a posting date for the social media post;
computing a duration between the render date and the posting date; and
adjusting the user rating score reliability factor based on the duration.

14. An electronic computation device comprising:
a processor;
a memory coupled to the processor, the memory containing instructions, that when executed by the processor, cause the electronic computation device to:
obtain a user rating score from a user for an artifact;
retrieve an online activity event from the user, wherein the online activity event is associated with the artifact;
compute an agreement factor between the online activity event and the user rating score; and
based on the agreement factor, generate a user rating score reliability factor.

15. The electronic computation device of claim 14, wherein the online activity event comprises a social media post, and wherein the memory further comprises instructions, that when executed by the processor, cause the electronic computation device to perform a natural language processing (NLP) analysis on the social media post.

16. The electronic computation device of claim 15, wherein the online activity event comprises a social media post, and wherein the memory further comprises instructions, that when executed by the processor, cause the electronic computation device to:
perform a sentiment analysis on the social media post to determine a post sentiment;
compare the post sentiment to a favorability of the user rating score; and
in response to determining a mismatch between post sentiment and the favorability, reduce the user rating score reliability factor.

17. The electronic computation device of claim 15, wherein the artifact comprises a service, and wherein the memory further comprises instructions, that when executed by the processor, cause the electronic computation device to:
determine a render date for the service;
determine a posting date for the social media post;
compute a duration between the render date and the posting date; and
adjust the user rating score reliability factor based on the duration.

18. A computer program product for an electronic computation device comprising a computer readable storage medium having program instructions embodied therewith, the program instructions executable by a processor to cause the electronic computation device to:
obtain a user rating score from a user for an artifact;
retrieve an online activity event from the user, wherein the online activity event is associated with the artifact;
compute an agreement factor between the online activity event and the user rating score; and
based on the agreement factor, generate a user rating score reliability factor.

19. The computer program product of claim 18, wherein the online activity event comprises a social media post, and wherein the computer program product further includes program instructions, that when executed by the processor, cause the electronic computation device to perform a natural language processing (NLP) analysis on the social media post.

20. The computer program product of claim 19, wherein the artifact comprises a service, and wherein the computer program product further includes program instructions, that when executed by the processor, cause the electronic computation device to:
determine a render date for the service;
determine a posting date for the social media post;
compute a duration between the render date and the posting date; and
adjust the user rating score reliability factor based on the duration.
